(19) United States
(12) Patent Application Publication
(10) Pub. No.: US 2012/0048746 A1
(43) Pub. Date: Mar. 1, 2012

(54) ANALYTE TEST STRIP WITH ELECTRICALLY DISTINGUISHABLE DIVIDED ELECTRODE

(75) Inventors: Stephen Patrick BLYTHE, Inverness (GB); Leanne Mills, Rosebank (GB); Stephen Mackintosh, Inverness (GB)

(73) Assignee: Cilag GmbH International, Zug (CH)

(21) Appl. No.: 12/871,616

(22) Filed: Aug. 30, 2010

(51) Int. Cl. G01N 27/26

(52) U.S. Cl. 205/777.5; 204/403.02; 204/406; 205/792

(57) ABSTRACT

An analyte test strip for use with a test meter includes a first insulating layer, a first electrically conductive layer disposed on the first insulating layer, a second insulating layer disposed above the first insulating layer, and a patterned spacer layer, positioned between the first insulating layer and the first electrically conductive layer, that defines a sample-receiving chamber. Moreover, the electrically conductive layer includes an electrode portion that is divided into a first electrode sub-portion and a second electrode sub-portion. The electrically conductive layer also includes (i) a first electrical contact pad in electrical communication with the first electrode sub-portion and configured to communicate an electrical response of the first electrical sub-portion to the test meter, and (ii) a second electrical contact pad in electrical communication with the second electrode sub-portion and configured to communicate an electrical response of the second electrical sub-portion to the test meter. In addition, the first electrode sub-portion is electrically isolated from the second electrode sub-portion and the first electrical contact pad is electrically isolated from the second electrical contact pad. Furthermore, the ratio of the area of the first electrode sub-portion and the area of the second electrode sub-portion is predetermined such that the ratio can be electrically distinguished by the test meter based on the first and second electrode sub-portion electrical responses.

### BACKGROUND OF THE INVENTION

1. Field of the Invention

The present invention relates, in general, to medical devices and, in particular, to analyte test strips, test meters and related methods.

2. Description of Related Art

The determination (e.g., detection and/or concentration measurement) of an analyte in a fluid sample is of particular interest in the medical field. For example, it can be desirable to determine glucose, cholesterol, acetaminophen and/or HbA1c concentrations in a sample of a bodily fluid such as urine, blood or interstitial fluid. Such determinations can be achieved using analyte test strips, based on, for example, photometric or electrochemical techniques, along with an associated test meter.

Typical electrochemical-based analyte test strips employ a plurality of electrodes (e.g., a working electrode and a reference electrode) and an enzymatic reagent to facilitate an electrochemical reaction with an analyte of interest and, thereby, determine the concentration of the analyte. For example, an electrochemical-based analyte test strip for the determination of glucose concentration in a blood sample can employ an enzymatic reagent that includes the enzyme glucose oxidase and the mediator ferricyanide. Such conventional analyte test strips are described in, for example, U.S. Pat. Nos. 5,708,247; 5,951,836; 6,241,862; and 6,284,125; each of which is hereby incorporated in full.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified perspective depiction of an analyte test strip according to an embodiment of the present invention;

FIG. 2 is a simplified exploded perspective view of the analyte test strip of FIG. 1;

FIG. 3A is a simplified top view of the first conductive layer with electrically distinguishable divided electrode of the analyte test strip of FIG. 1;

FIGS. 3B and 3C are simplified top views of first conductive layers, each with an electrically distinguishable divided electrode, as can be employed in the analyte test strip of FIG. 1 as an alternative to the first conductive layer of FIG. 3A;

FIG. 4 is simplified depiction of the first conductive layer of FIG. 3A in use with a test meter according to an embodiment of the present invention;

FIG. 5 is a simulated electrical response (i.e., electrical current versus time) for a first electrode sub-portion (designated as “left”), a second electrode sub-portion (designated as “right”), and the sum of the left and right electrode sub-portions of an analyte test strip according to an embodiment of the present invention wherein the left electrode sub-portion area is 25% of the total area of a first electrode portion and the right electrode sub-portion area is 75% of the total area of the first electrode portion;

FIG. 6 is a simulated electrical response (i.e., electrical current versus time) for a first electrode sub-portion (designated as “left”), a second electrode sub-portion (designated as “right”) and the sum of the left and right electrode sub-portions of an analyte test strip according to an embodiment of the present invention wherein the left electrode sub-portion area is 75% of the total area of a first electrode portion and the right electrode sub-portion area is 25% of the total area of the first electrode portion;

FIGS. 7A and 7B are graphs of a current sum ratio versus the ratio of electrode sub-portion areas (also referred to as electrode area ratio) for analyte test strips according to various embodiments of the present invention;

FIGS. 8A and 8B and graphs depicting probability density versus electrode portion division arrangements for an analyte test strip according to an embodiment of the present invention configured with four different electrode portion division arrangements (FIG. 8A) and three different electrode portion division arrangements (FIG. 8B);

FIG. 9 is a graph depicting probability density versus electrode portion division arrangement for an analyte test strip according to an embodiment of the present invention configured with five electrode portion division arrangements; and

FIG. 10 is a flow diagram depicting stages in a process for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

In general, analyte test strips (e.g., an electrochemical-based analyte test strip for determining glucose in a bodily fluid sample) for use with a test meter according to embodiments of the present invention include a first insulating layer, a first electrically conductive layer disposed on the first insulating layer, a second insulating layer disposed above the first insulating layer, and a patterned spacer layer, positioned between the first insulating layer and the first electrically conductive layer, that defines a sample-receiving chamber. Moreover, the electrically conductive layer includes an electrode portion (also referred to as a first electrode portion) that is divided into a first electrode sub-portion and a second electrode sub-portion. The electrically conductive layer also includes (i) a first electrical contact pad in electrical communication with the first electrode sub-portion and configured to communicate an electrical response (such as an electrical current response) of the first electrical sub-portion to the test meter and (ii) a second electrical contact pad in electrical communication with the second electrode sub-portion and configured to communicate an electrical response (such as an electrical current response) of the second electrical sub-portion to the test meter.

In addition, the first electrode sub-portion is electrically isolated from the second electrode sub-portion and the first electrical contact pad is electrically isolated from the second electrical contact pad. Furthermore, the ratio of the area of the first electrode sub-portion and the area of the second electrode sub-portion is predetermined such that the ratio can be electrically distinguished (discerned) by the test meter based on the first and second electrode sub-portion electrical responses.

Since analyte test strips according to embodiments of the present invention include an electrode portion (e.g., an electrode portion that serves as a working electrode) that has electrically isolated first and second electrode sub-portions, the electrode portion is also referred to herein as an electrically-distinguishable divided electrode.

Analyte test strips according to embodiments of the present invention are beneficial in that the analyte test strips can be readily identified as suitable or unsuitable for use by a test meter based on the ratio of the area of the first electrode sub-portion and the area of the second electrode sub-portion. Such identification beneficially enables the test meter to proceed with analyte determination only when appropriate, thus avoiding potentially improper, erroneous or inaccurate analyte determinations based on the use of unsuitable analyte test strips.

The identification can occur, for example, by matching the ratio of the first and second electrode sub-portion areas to a predetermined ratio(s) of analyte test strips that are suitable for use. It is envisioned that various commercial markets can be supplied with analyte test strips according to embodiments of the present invention that are configured with different predetermined ratios of the first and second electrode sub-portion areas. For example, commercial market “A” can be supplied with analyte test strips that have a ratio of 3:1, while commercial market “B” can be supplied with analyte test strips that have a ratio of 1:3. In such a scenario, signal processing modules of test meters supplied to users in markets “A” and “B” would be programmed to identify analyte test strips with the appropriate ratio as suitable for use and analyte test strips with inappropriate ratios as unsuitable for use. If an analyte test strip configured for market A where to be inadvertently employed in market B, a market B test meter would determine that the analyte test strip was unsuitable for use and, if desired, display an appropriate message to a user.

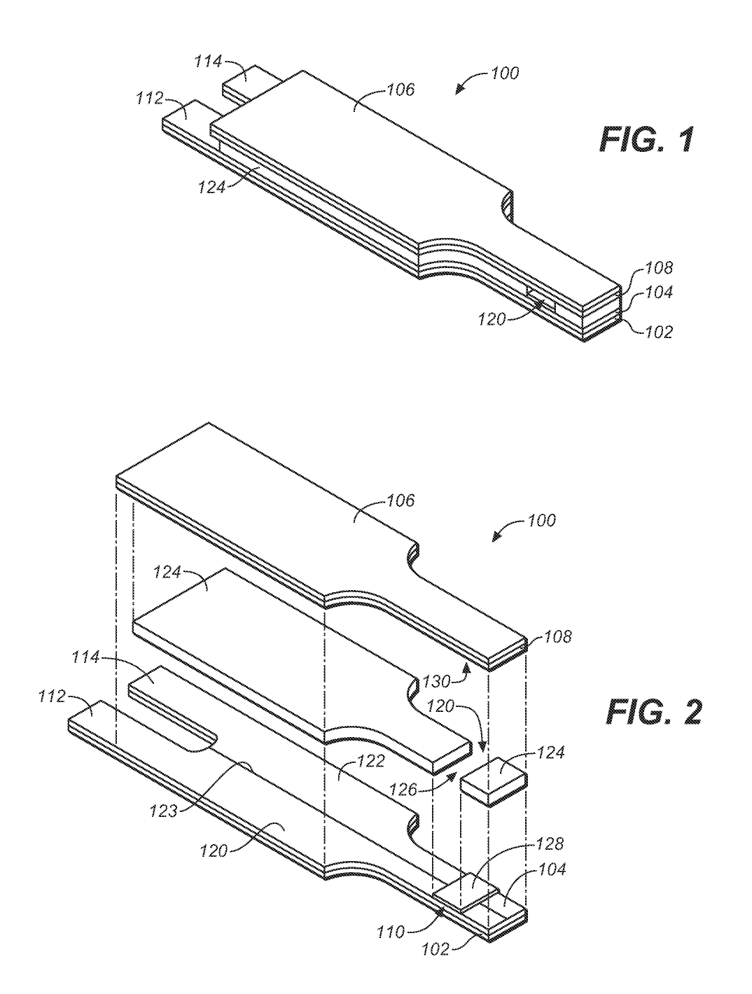

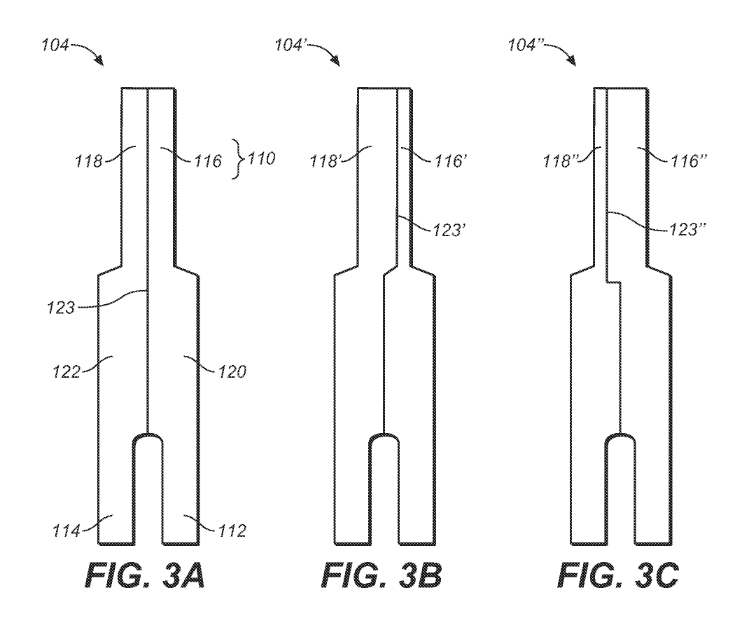

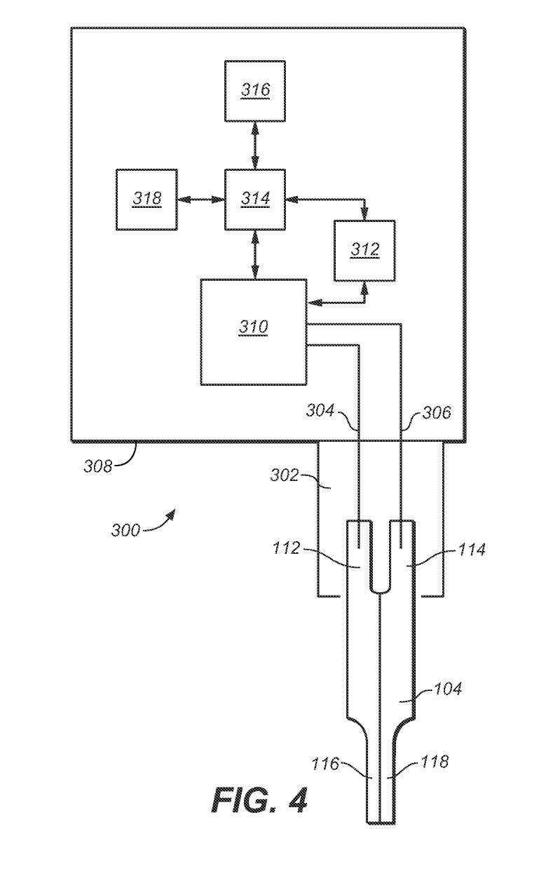

FIG. 1 is a simplified perspective depiction of an analyte test strip 100 according to an embodiment of the present invention. FIG. 2 is a simplified exploded perspective view of analyte test strip 100. FIG. 3A is a simplified top view of the first conductive layer with an electrically distinguishable divided electrode (i.e., an electrode portion with first and second electrode sub-portions) of analyte test strip 100. FIGS. 3B and 3C are simplified top views of first conductive layers, each with an electrically distinguishable divided electrode, as can be employed in analyte test strip 100 as an alternative to the first conductive layer depicted in FIG. 3A. FIG. 4 is simplified depiction of the first conductive layer of FIG. 3A in use with a test meter 300 according to an embodiment of the present invention.

Referring to FIGS. 1, 2, 3A-3C, and 4, analyte test strip 100 for use with a test meter (described further herein, for example with respect to the embodiment of FIG. 4) according to an embodiment of the present invention includes a first insulating layer 102, with first electrically conductive layer 104 disposed thereon, and a second insulating layer 106, with second electrically conductive layer 108 disposed thereon. Second insulating layer 106 is disposed above first insulating layer 102

First electrically conductive layer 104 includes first electrode portion 110 (also referred to simply as electrode portion 110), first electrical contact pad 112 and second electrical contact pad 114. First electrode portion 110 is divided into a first electrode sub-portion 116 and a second electrode sub-portion 118 (see FIG. 3A). First electrical contact pad 112 is in electrical communication with first electrode sub-portion 116 and configured to communicate an electrical response (such as an electrical current response) of the first electrical sub-portion to the test meter. Second electrical contact pad 114 is in electrical communication with the second electrode sub-portion 118 and is configured to communicate an electrical response of the second electrical sub-portion to the test meter. In addition, electrical first and second contact pads 112 and 114 are configured to operatively interface with the test meter (see, for example, FIG. 4).

Analyte test strip 100 also includes connection tracks 120 and 122 that provide electrical communication between electrical contact pads 112 and 114 and first electrode sub-portion 116 and second electrode sub-portion 118, respectively.

Referring to FIG. 3A in particular, analyte test strip 100 includes a scribe line 123 that divides first electrically conductive layer 104 into first electrode sub-portion 116, connection track 120, first electrical contact pad 112, second electrode sub-portion 118, second electrical contact pad 116, and connection track 122. Scribe line 123 is configured such that it electrically isolates first electrode sub-portion 116, connection track 120 and first electrical contact pad 112 from second electrode sub-portion 118, connection track 122 and second electrical contact pad 114.

Scribe line 123 can be created, for example, via laser ablation of a deposited first electrically conductive layer or any other suitable technique known to one skilled in the art and can have a width (measured from left to right in the orientation of FIG. 3A) in the range of, for example, 1 μm to 200 μm. To minimize disruption in the flow of a bodily fluid sample into sample-receiving chamber 126 of analyte test strip 100, it can be beneficial for scribe line 123 to be in a straight line configuration across first electrode portion 110. A straight line configuration is depicted in, for example, FIGS. 3A, 3B and 3C.

Analyte test strip 100 also includes a patterned spacer layer 124 positioned between second electrically conductive layer 108 and first electrically conductive layer 104. Patterned spacer layer 124 defines a sample-receiving chamber 126 therein. Analyte test strip 100 also includes a reagent layer 128 and second electrically conductive layer 108 includes a second electrode portion 130, as depicted in FIGS. 1 and 2.

First insulating layer 102 and second insulating layer 106 can be formed, for example, of a plastic (e.g., PET, PETG, polyimide, polycarbonate, polystyrene), silicon, ceramic, or glass material. For example, the first and second insulating layers can be formed from a 7 mil polyester substrate.

In the embodiment of FIGS. 1, 2, and 3A, first electrode portion 110, along with second electrode portion 130 of second electrically conductive layer 108, are configured to electrochemically determine analyte concentration in a bodily fluid sample (such as glucose in a whole blood sample) using any suitable electrochemical-based technique known to one skilled in the art. First electrode portion 110 can be configured, for example, as a working electrode while second electrode portion 130 can, for example, be configured as a counter/reference electrode such that analyte test strip 100 is configured as an electrochemical-based analyte test strip. In this scenario, first and second electrode sub-portions 116 and 118 would be working electrode sub-portions and the sum of their electrical responses employed by a test meter during the determination of an analyte (for example, glucose) in a bodily fluid sample (such as a whole blood sample) introduced into sample-receiving chamber 126.

The first and second conductive layers, 104 and 108 respectively, can be formed of any suitable conductive material such as, for example, gold, palladium, carbon, silver, platinum, tin oxide, iridium, indium or combinations thereof (e.g., indium doped tin oxide). Moreover, any suitable technique can be employed to form the first and second conductive layers including, for example, sputtering, evaporation, electro-less plating, screen-printing, contact printing or gravure printing. For example, first conductive layer 104 can be a sputtered palladium layer and second conductive layer 108 can be a sputtered gold layer. A typical but non-limiting thickness for the first and second conductive layers is in the range of 5 nm to 100 nm.

Patterned spacer layer 124 serves to bind together first insulating layer 102 (with conductive layer 104 thereon) and second insulating layer 106 (with second electrically conductive layer 108 thereon), as illustrated in FIGS. 1 and 2. Patterned spacer layer 124 can be, for example, a double-sided pressure sensitive adhesive layer, a heat activated adhesive layer, or a thermo-setting adhesive plastic layer. Patterned spacer layer 124 can have, for example, a thickness in the range of from about 1 μm to about 500 μm, preferably between about 10 μm and about 400 μm, and more preferably between about 40 μm and about 200 μm.

Reagent layer 128 can be any suitable mixture of reagents that selectively react with an analyte such as, for example glucose, in a bodily fluid sample to form an electroactive species, which can then be quantitatively measured at an electrode of analyte test strips according to embodiments of the present invention. Therefore, reagent layer 128 can include at least a mediator and an enzyme. Examples of suitable mediators include ferricyanide, ferrocene, ferrocene derivatives, osmium bipyridyl complexes, and quinone derivatives. Examples of suitable enzymes include glucose oxidase, glucose dehydrogenase (GDH) using a pyrroloquinoline quinone (PQQ) co-factor, GDH using a nicotinamide adenine dinucleotide (NAD) co-factor, and GDH using a flavin adenine dinucleotide (FAD) co-factor. Reagent layer 128 can be formed using any suitable technique.

Scribe line 123 serves to divide first electrode portion 110 into two electrically distinguishable sub-portions, namely first electrode sub-portion 116 and second electrode sub-portion 118 in a side-by-side configuration. In FIG. 3A, scribe line 123 serves to create an arrangement wherein the ratio of the area of the first electrode sub-portion 116 to the area of the second electrode sub-portion 118 is 1:1. In other words, each of the electrode sub-portions is 50% of total area of first electrode portion 110. A side-by-side configuration, as depicted in, for example, FIGS. 3A, 3B and 3C, provides for relatively simple manufacturing of analyte test strips according to embodiments of the present invention by enabling, for example, registration free positioning of patterned spacer layer 124.

Alternatively and as depicted in FIG. 3B, scribe line 123′ serves to divide the first electrode portion of first electrically conductive layer 104′ into two electrically distinguishable sub-portions, namely first electrode sub-portion 116′ and second electrode sub-portion 118′ in a side-by-side configuration. In FIG. 3B, scribe line 123′ serves to create an arrangement wherein the ratio of the area of the first electrode sub-portion 116′ to the area of the second electrode sub-portion 118′ is 1:3. In other words, the area of the first electrode sub-portion 116′ is 25% of total area of first electrode portion and the area of the second electrode sub-portion 118′ is 75% of total area of the first electrode portion.

In another alternative and as depicted in FIG. 3C, scribe line 123″ serves to divide first electrode portion of first electrically conductive layer 104″ into two electrically distinguishable sub-portions, namely first electrode sub-portion 116″ and second electrode sub-portion 118″ in a side-by-side configuration. In FIG. 3C, scribe line 123″ serves to create an arrangement wherein the ratio of the area of the first electrode sub-portion 116″ to the area of the second electrode sub-portion 118″ is 3:1. In other words, the area of the first electrode sub-portion 116″ is 75% of total area of first electrode portion and the area of the second electrode sub-portion 118″ is 25% of total area of first electrode portion.

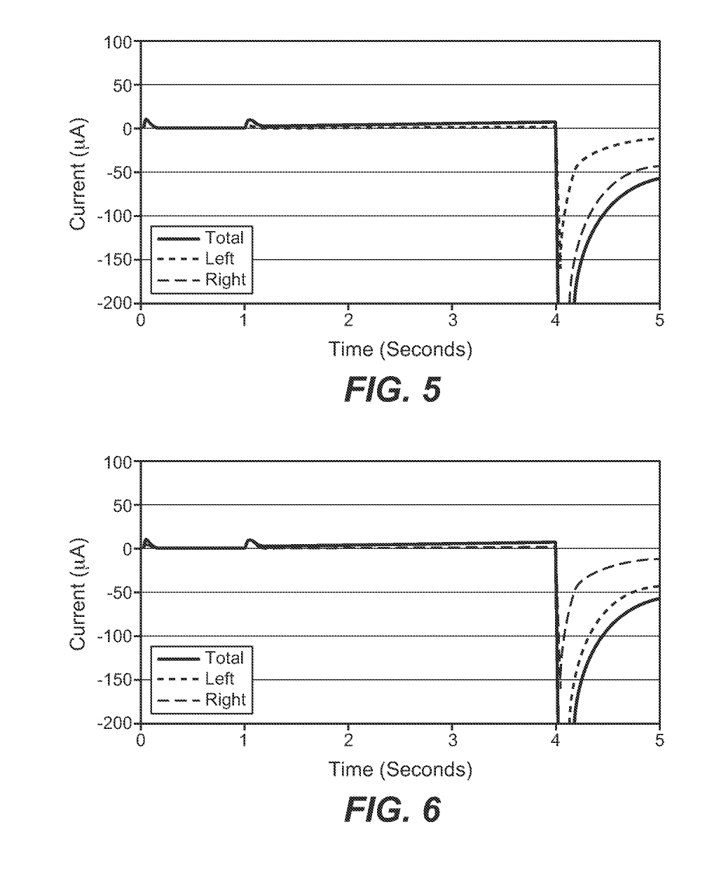

FIGS. 3A, 3B and 3C illustrate how first electrode portion 110 can be divided into electrode sub-portions of various predetermined area ratios by scribe line 123. The predetermined area ratios are selected such that a test meter is able to electrically distinguish the ratio based on the electrical response of the first electrode sub-portion and the electrical response of the second electrode sub-portion. FIGS. 5 and 6 illustrate two different electrical response scenarios that could be employed to identify an analyte test strip.

FIG. 5 is a simulated electrical response (i.e., electrical current versus time) for a first electrode sub-portion (designated as “left”), a second electrode sub-portion (designated as “right”) and the sum of the left and right electrode sub-portion currents of an analyte test strip according to an embodiment of the present invention. In FIG. 5, the left electrode sub-portion area is 25% of the total first electrode portion area and the right electrode sub-portion area is 75% of the total electrode portion area. Therefore, FIG. 5 represents an electrical response as would be created by an analyte test strip according to embodiments of the present invention that includes the electrically conductive layer of FIG. 3B.

FIG. 6 is a simulated electrical response (i.e., current versus time) for a first electrode sub-portion (designated as “left”), a second electrode sub-portion (designated as “right”) and the sum of the left and right electrode sub-portion currents of an analyte test strip according to an embodiment of the present invention wherein the left electrode sub-portion area is 75% of the total first electrode portion area and the right electrode sub-portion area is 25% of the total electrode portion area. Therefore, FIG. 6 represents an electrical response as would be created by an analyte test strip according to the embodiments of the present invention that includes the electrically conductive layer of FIG. 3C.

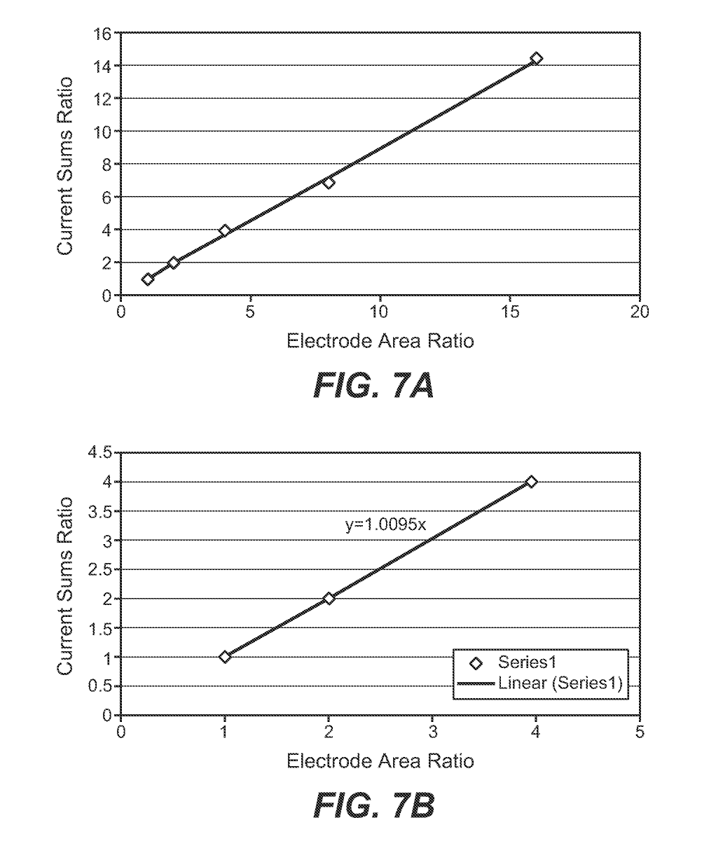

Based on the above description, one skilled in the art will recognize that analyte test strips according to embodiments of the present invention are characterized in that the ratio of the areas of the first and second electrode sub-portions can be distinguished based on an analysis of their respective electrical responses. For example, the ratio can be ascertained based on a current sums ratio obtained from an analysis of the electrical responses. FIGS. 7A and 7B are graphs of a current sum ratio versus the ratio of electrode areas for analyte test strips according to various embodiments of the present invention that illustrates the relationship between current sums ratio and electrode area ratio. The data of FIGS. 7A and 7B were obtained from a mathematical model of analyte test strip electrical current response behavior.

In FIGS. 7A and 7B, the electrical current responses of first and second electrode sub-portions were summed over a suitable predetermined time interval and the resulting “current sums” used to calculate the “current sums ratio” of the y-axes. In FIGS. 7A and 7B, both the y-axes and the x-axes are represented as a single numeral with the second numeral in the ratio being constant at 1. For example, a ratio of 2:1 is simply represented as 2. Therefore, an electrode area ratio plotted as 4, represents a 4:1 ratio for the first and second electrode sub-portions (i.e., the first electrode sub-portion being 80% of the total electrode portion and the second electrode sub-portion being 20% of the total electrode sub-portion).

The data of FIG. 7A has a slope (i.e., 0.88) that is significantly less than the ideal slope of 1.0. It is hypothesized without being bound that this non-ideality is due to electrode sub-portion edge effects, particularly for the smaller of the first and second electrode sub-portions. If it is desired to avoid such edge effects and any related complications with respect to a test meter's ability to electrically distinguish the ratio of first and second electrode sub-portion areas, then the first and second electrode sub-portion area ratio can be limited to, for example, ratios in the range of 1:1 to 4:1. Such a limited range of electrode sub-portion area ratios results in minimal edge effects and a slope nearly equal to 1 (see FIG. 7B).

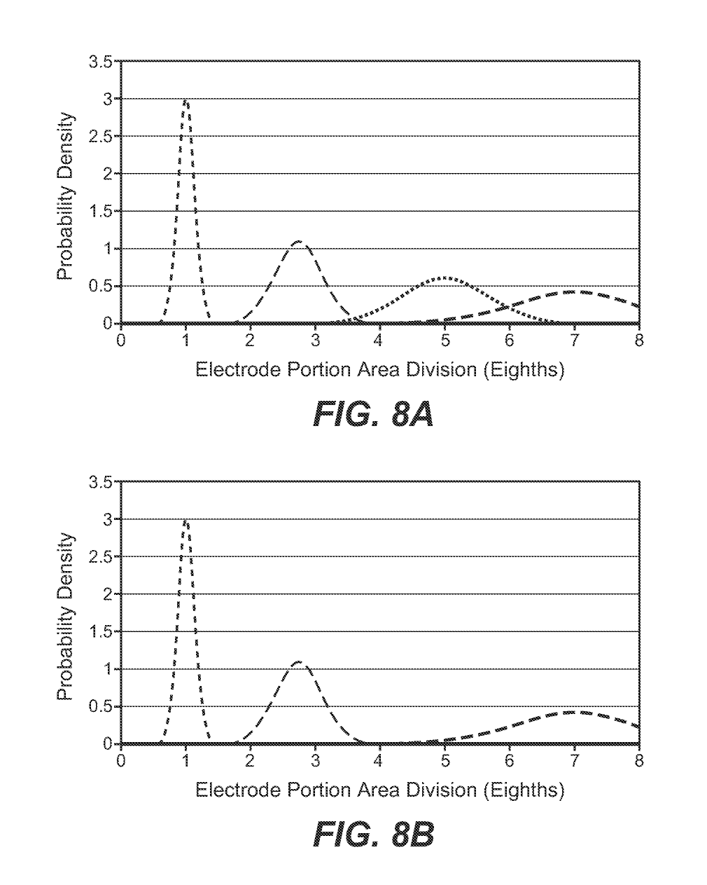

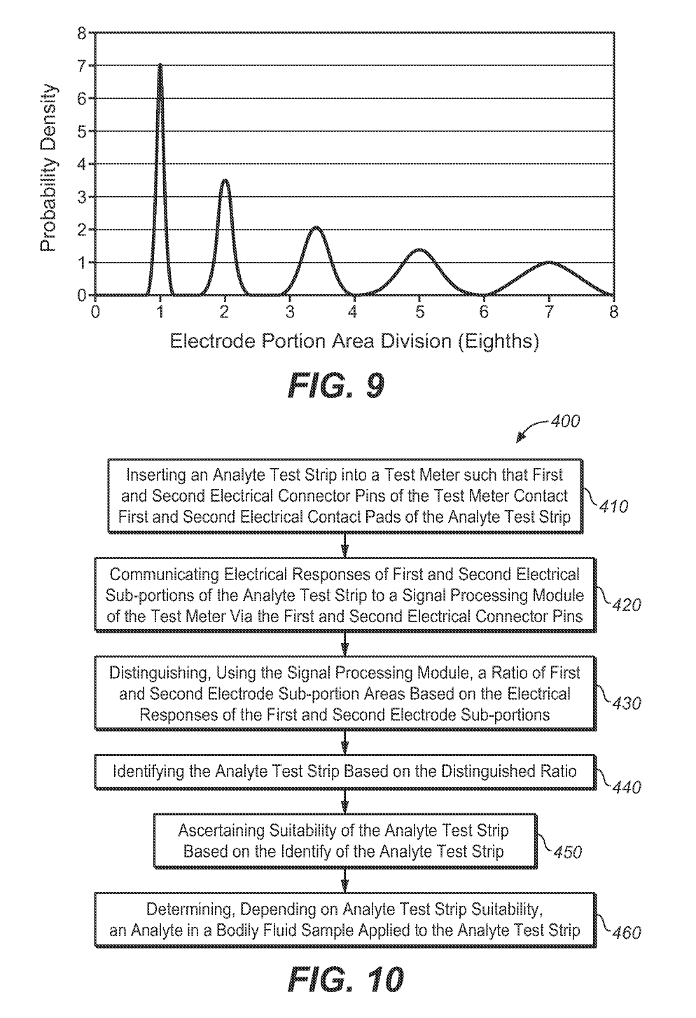

FIGS. 8A and 8B and graphs depicting probability density versus electrode portion division arrangements for an analyte test strip according to an embodiment of the present invention configured with four different electrode portion division arrangements (FIG. 8A) and three different electrode portion division arrangements (FIG. 8B). FIG. 9 is a graph depicting probability density versus electrode portion division arrangement for an analyte test strip according to another embodiment of the present invention configured with five electrode portion division arrangements. FIG. 8A depicts 4 curves, namely curves for electrode portions divided into area ratios of 1:8, 2.75:5:25, 5:3 and 7:1. FIG. 8B depicts 3 curves, namely curves for electrode portions divided into ratios of 1:7, 2:75:5.25, and 7:1. FIG. 9 depicts 5 probability density curves, namely curves for electrode portions divided into ratios of 1:8, 2:6, 3.5:4.5, 5:3 and 7:1.

In FIGS. 8A, 8B and 9, the Probability Density of the y-axis was calculated (using the function NORMDIST in the commercially available software Excel from Microsoft) as a normal density function with mean μⱼ, and standard deviation cμⱼ, as follows:

φ(x;μⱼ,(cμⱼ)²

where:

x=electrode portion area division; and

j=an index

c=a measure of variability

In FIGS. 8A and 8B, c was assumed to be 0.133. In FIG. 9, c was assumed to be 0.04. In FIG. 8A, the probability density curves for the divisions of 5:3 and 7:1 exhibit significant overlap. This overlap indicates that normal measurement variability (under the assumptions used to generate FIG. 8A) would result in a test meter not being able to accurately and repeatedly distinguish an analyte test strip with a ratio of 5:3 from an analyte test strip with a ratio of 7:1. However, in FIG. 8B, the curves are well separated with little to essentially no overlap between the curves. This indicates that a test meter could accurately and repeatedly distinguish between analyte test strips with ratios of 1:1, 2.75:5.25 and 7:1.

In general therefore, a non-limiting method for predetermining suitable ratios of area for the first and second electrode sub-portions is to analyze probability density overlap (as in FIGS. 8A and 8B) and to predetermine the ratios to minimize or essentially eliminate overlap between adjacent probability density curves. However, a comparison of FIG. 8A to FIG. 9 (which depicts 5 non-overlapping curves) indicates how such overlap is dependent on the variability c. Therefore, once apprised of the present disclosure one of skill in the art will recognize that such a probability density curve overlap analysis requires a suitable knowledge of measurement variability.

In general, test meters for use with an analyte test strip according to embodiments of the present invention include a test strip receiving module, with a first electrical connector pin, a second electrical connector pin, and a signal processing module. It should be noted that the analyte test strip used with test meters according to embodiments of the present invention are analyte test strips with a divided electrically distinguishable electrode as described herein.

The first electrical connector pin of the test meter is configured to contact a first electrical contact pad of an analyte test strip, with the first electrical contact pad being in electrical communication with a first electrode sub-portion of the analyte test strip. The first electrical connector pin is also configured to communicate an electrical response (e.g., a current response as depicted in FIGS. 5 and 6) of the first electrical sub-portion to the signal processing module. The second electrical connector pin is configured to contact a second electrical contact pad of the analyte test strip, with the second electrical contact pad being in electrical communication with a second electrode sub-portion of the analyte test strip. The second electrical connector pin is also configured to communicate an electrical response (such as a current response as depicted in FIGS. 5 and 6) of the second electrical sub-portion to the signal processing module.

The signal processing module of the test meter is configured to electrically distinguish a ratio of the area of the first electrode sub-portion and the area of the second electrode sub-portion based on the electrical response of the first electrical sub-portion and the electrical response of the second electrical sub-portion and, thereby, identify the analyte test strip as, for example, suitable or unsuitable for use with the test meter.

Referring again to FIG. 4, a test meter 300 for use with an analyte test strip according to embodiment of the present invention includes a test strip receiving module 302, with a first electrical connector pin 304 and a second electrical connector pin 306, and a signal processing module 308. First electrical connector pin 304 is configured to contact first electrical contact pad 112 of an analyte test trip, with first electrical contact pad 112 being in electrical communication with a first electrode sub-portion 116 of the analyte test strip. In addition, first electrical connector pin 304 is configured to communicate an electrical response of first electrical sub-portion 116 to signal processing module 308.

Second electrical connector pin 306 is configured to contact second electrical contact pad 114 of an analyte test trip, with first electrical contact pad 114 being in electrical communication with a first electrode sub-portion 118 of the analyte test strip. In addition, first electrical connector pin 306 is configured to communicate an electrical response of first electrical sub-portion 118 to signal processing module 308.

Signal processing module 308 is configured to electrically distinguish a ratio of the area of the first electrode sub-portion and the area of the second electrode sub-portion based on the electrical response of the first electrode sub-portion and the electrical response of the second electrode sub-portion and, thereby, identify the analyte test strip.

In the embodiment of FIG. 4, signal processing module 308 includes a test voltage unit 310, a current measurement unit 312, a processor unit 314, a memory unit 316, and a visual display module 318 (see FIG. 4). One skilled in the art will appreciate that the test meter 300 can also employ a variety of sensors and circuits that are not depicted in simplified FIG. 4 during identification of an analyte test strip and during determination of an analyte. Moreover, test voltage unit 310, current measurement unit 312, processor unit 314, memory unit 316, and visual display module 318 can also serve to perform additional test meter functions including, for example, the functions described in co-pending U.S. patent application Ser. No. 12/464,935, which is hereby incorporated in full by reference.

FIG. 10 is a flow diagram depicting stages in a method 400 for determining an analyte in a bodily fluid sample according to an embodiment of the present invention. Method 400 includes, at step 410, inserting an analyte test strip into a test meter such that (i) first electrical connector pin of the test meter contacts a first electrical contact pad of an analyte test trip, the first electrical contact pad being in electrical communication with a first electrode sub-portion of the analyte test strip; and (ii) a second electrical connector pin of the test meter contacts a second electrical contact pad of an analyte test trip, the second electrical contact pad being in electrical communication with a second electrode sub-portion of the analyte test strip.

At step 420 of method 400, an electrical response of the first electrical sub-portion and an electrical response of the second electrical sub-portion are communicated to a signal processing module of the test meter via the first electrical connector pin and the second electrical connector pin respectively. The electrical response of the first electrode sub-portion and the second electrode sub-portion are generated in essentially the same electrochemical manner as electrical responses generated by an electrode of a conventional analyte test strips. However, analyte test strips employed in method 400 generate electrical responses at both a first electrode sub-portion and a second electrode sub-portion (for example first and second working electrode sub-portions) rather than a conventional single unitary electrode portion (e.g., a single unitary working electrode).

Employing the signal processing module in step 430 of FIG. 10, a ratio of the area of the first electrode sub-portion and the area of the second electrode sub-portion is distinguished based on the electrical response of the first electrical sub-portion and the electrical response of the second electrical sub-portion.

The analyte test strip is identified based on the distinguished ratio in step 440; the suitability of the analyte test strip for use with the test meter is ascertained based on the identity of the analyte test strip in step 450; and, depending on the suitability of the analyte test strip, an analyte in a bodily fluid sample applied to the analyte test strip is determined at step 460 of method 400.

To determine the analyte, a sum of the first electrode sub-portion electrode electrical response and the second electrode sub-portion electrical response can, if desired, be employed to represent the first electrode portion response. Such a sum is depicted in FIGS. 5 and 6 as the solid line labeled “Total”.

Method 400 can be readily modified by one skilled in the art to incorporate any of the techniques, benefits and characteristics of analyte test strips according to embodiments of the present invention and described herein, as well as those of test meters according to embodiments of the present invention described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. An analyte test strip for use with a test meter, the analyte test strip comprising:
a first insulating layer;
a first electrically conductive layer disposed on the first insulating layer, the first electrically conductive layer including:
an electrode portion, the electrode portion divided into a first electrode sub-portion and a second electrode sub-portion;
a first electrical contact pad in electrical communication with the first electrode sub-portion and configured to communicate an electrical response of the first electrical sub-portion to the test meter; and
a second electrical contact pad in electrical communication with the second electrode sub-portion and configured to communicate an electrical response of the second electrical sub-portion to the test meter;
a second insulating layer disposed above the first insulating layer;
a patterned spacer layer positioned between the first insulating layer and the first electrically conductive layer, the patterned spacer layer defining a sample-receiving chamber therein;
wherein the first electrode sub-portion is electrically isolated from the second electrode sub-portion and the first electrical contact pad is electrically isolated from the second electrical contact pad; and
wherein the ratio of the area of the first electrode sub-portion and the area of the second electrode sub-portion is predetermined such that the ratio can be electrically distinguished by the test meter based on the electrical response of the first electrode sub-portion and the electrical response of the second electrode sub-portion.

2. The analyte test strip of claim 1 wherein the ratio of the area of the first electrode sub-portion and the area of the second electrode sub-portion is in the range of 1:1 to 4:1.

3. The analyte test strip of claim 2 wherein the ratio of the first electrode sub-portion and the area of the second electrode sub-portion is one of a 1:1 ratio, a 3:1 ratio and a 1:3 ratio.

4. The analyte test strip of claim 1 wherein the ratio of the first electrode sub-portion and the area of the second electrode sub-portion is one of a 1:8 ratio, a 2.75:5.25 ratio and a 7:1 ratio.

5. The analyte test strip of claim 1 wherein the ratio of the first electrode sub-portion and the area of the second electrode sub-portion is one of a 1:8 ratio, a 2:6 ratio, a 3.5:4.5 ratio, a 5:3 ratio, and a 7:1 ratio.

6. The analyte test strip of claim 1 further including a scribe line and wherein the scribe line divides the electrode portion into a first electrode sub-portion and a second electrode sub-portion.

7. The analyte test strip of claim 6 wherein the scribe line is configured in a straight line across the electrode portion.

8. The analyte test strip of claim 6 wherein the scribe line has a width in the range of 1 μm to 200 μm.

9. The analyte test strip of claim 1 wherein the electrode portion is configured as a working electrode.

10. The analyte test strip of claim 1 wherein the first electrically conductive layer is a palladium layer.

11. The analyte test strip of claim 1 further including a second electrically conductive layer disposed on the second insulating layer.

12. The analyte test strip of claim 1 wherein the electrical response of the first electrode sub-portion is a current response and electrical response of the second electrode sub-portion is a current response.

13. The analyte test strip of claim 1 wherein the analyte test strip is an electrochemical-based analyte test strip.

14. The analyte test strip of claim 10 wherein the analyte test strip is configured for the determination of glucose in a whole blood sample.

15. The analyte test strip of claim 1 wherein the first electrode sub-portion and the second electrode sub-portion are in a side-by-side configuration.

16. The analyte test strip of claim 1 wherein the electrical response of the first electrode sub-portion is an electrical current response and the electrical response of the second electrode sub-portion is an electrical current response.

17. A test meter for use with an analyte test strip, the test meter comprising:
a test strip receiving module with a first electrical connector pin and a second electrical connector pin; and
a signal processing module,
wherein the first electrical connector pin is configured:
to contact a first electrical contact pad of an analyte test trip, the first electrical contact pad being in electrical communication with a first electrode sub-portion of the analyte test strip; and
to communicate an electrical response of the first electrical sub-portion to the signal processing module; and
wherein the second electrical connector pin is configured:
to contact a second electrical contact pad of the analyte test trip, the second electrical contact pad being in electrical communication with a second electrode sub-portion of the analyte test strip; and
to communicate an electrical response of the second electrical sub-portion to the signal processing module; and
wherein the signal processing module is configured to electrically distinguish a ratio of the area of the first electrode sub-portion and the area of the second electrode sub-portion based on the electrical response of the first electrode sub-portion and the electrical response of the second electrode sub-portion and, thereby, identify the analyte test strip.

18. The test meter of claim 17 wherein the signal processing module is configured to electrically distinguish the ratio of area as a ratio in the range of 1:1 to 4:1.

19. The test meter of claim 17 wherein the signal processing module is configured to electrically distinguish the ratio of area as one of a 1:1 ratio, a 3:1 ratio and a 1:3 ratio.

20. The test meter of claim 17 wherein the signal processing module is configured to electrically distinguish the ratio of area as one of a 1:8 ratio, a 2.75:5.25 ratio and a 7:1 ratio.

21. The test meter of claim 17 wherein the signal processing module is configured to electrically distinguish the ratio of area as one of a 1:8 ratio, a 2:6 ratio, a 3.5:4.5 ratio, a 5:3 ratio, and a 7:1 ratio.

22. The test meter of claim 17 wherein the test meter is further configured to determine an analyte in a bodily fluid sample applied to the analyte test strip.

23. The test meter of claim 17 wherein the electrical response of the first electrode sub-portion is a current response and electrical response of the second electrode sub-portion is a current response.

24. The test meter of claim 17 wherein the test meter further includes a display module and wherein the display module and signal processing module are configured to display a message indicating the suitability for use of the analyte test strip based on the identity of the analyte test strip.

25. The test meter of claim 17 wherein the analyte test strip is an electrochemical-based analyte test strip.

26. The test meter of claim 25 wherein the analyte test strip is configured for the determination of glucose in a whole blood sample.

27. A method for the determination of an analyte in a bodily fluid sample, the method comprising:
inserting an analyte test strip into a test meter such that:
a first electrical connector pin of the test meter contacts a first electrical contact pad of an analyte test trip, the first electrical contact pad being in electrical communication with a first electrode sub-portion of the analyte test strip; and
a second electrical connector pin of the test meter contacts a second electrical contact pad of an analyte test trip, the second electrical contact pad being in electrical communication with a second electrode sub-portion of the analyte test strip,
communicating an electrical response of the first electrode sub-portion and an electrical response of the second electrode sub-portion to a signal processing module of the test meter via the first electrical connector pin and the second electrical connector pin respectively;
distinguishing, by employment of the signal processing module, a ratio of the area of the first electrode sub-portion and the area of the second electrode sub-portion based on the electrical response of the first electrode sub-portion and the electrical response of the second electrode sub-portion;
identifying the analyte test strip based on the distinguished ratio;
ascertaining the suitability of the analyte test strip for use with the test meter based on the identity of the analyte test strip; and
determining, dependent on the suitability of the analyte test strip, an analyte in a bodily fluid sample applied to the analyte test strip.

28. The method of claim 27 wherein the first electrode sub-portion and the second electrode sub-portion are sub-portions of a working electrode portion of the analyte test strip.

29. The method of claim 27 wherein the signal processing module is configured to electrically distinguish the ratio of area as a ratio in the range of 1:1 to 4:1.

30. The method of claim 27 wherein the signal processing module is configured to electrically distinguish the ratio of area as one of a 1:1 ratio, a 3:1 ratio and a 1:3 ratio.

31. The method of claim 27 wherein the signal processing module is configured to electrically distinguish the ratio of area as one of a 1:8 ratio, a 2.75:5.25 ratio and a 7:1 ratio.

32. The method of claim 27 wherein the signal processing module is configured to electrically distinguish the ratio of area as one of a 1:8 ratio, a 2:6 ratio, a 3.5:4.5 ratio, a 5:3 ratio, and a 7:1 ratio.

33. The method of claim 27 wherein the electrical response of the first electrode sub-portion is a current response and electrical response of the second electrode sub-portion is a current response

34. The method of claim 27 wherein the analyte is glucose and the bodily fluid sample is a whole blood sample.

35. The method of claim 27 further including the step of:
displaying, on a display module of the test meter, a message indicating the suitability for use of the analyte test strip based on the identity of the analyte test strip.

36. The method of claim 27 wherein the analyte test strip is configured as an electrochemical-based analyte test strip.

37. The method of claim 27 further including the step of:
displaying, on a display module of the test meter, a message indicating both the suitability for use of the analyte test strip based on the identity of the analyte test strip and the results of the determination step.
